(19) United States
(12) Patent Application Publication
(10) Pub. No.: US 2014/0355615 A1
(43) Pub. Date: Dec. 4, 2014

(54) TRAFFIC FORWARDING

(71) Applicant: Hangzhou H3C Technologies Co., Ltd., Hangzhou (CN)

(72) Inventor: Huifeng Chang, Beijing (CN)

(21) Appl. No.: 14/374,195

(22) PCT Filed: Jan. 24, 2013
(86) PCT No.: PCT/CN2013/070914

§ 371 Date: Jul. 23, 2014

(30) Foreign Application Priority Data
Feb. 2, 2012 (CN) 201210023000.4

(51) Int. Cl. H04L 12/937; H04L 12/741

(52) U.S. Cl. CPC H04L 49/253; H04L 45/745
USPC 370/392

(57) ABSTRACT

The present disclosure provides a method and an apparatus for traffic forwarding, wherein the method is applied to a control apparatus in a network, including: determining a switch apparatus having egress ports associated with N equal-cost paths simultaneously in the network, wherein N is equal to or greater than 2; informing the switch apparatus to create a traffic distribution group, and to add the egress ports on the switch apparatus associated with the N equal-cost paths to the traffic distribution group; and issuing, to the switch apparatus, a traffic table corresponding to the traffic distribution group, wherein the traffic table includes a destination address of the N equal-cost paths and the traffic distribution group used as an egress port through which the switch apparatus forwards traffic to the destination address.

### BACKGROUND

Port aggregation is to bind two or more physical ports on a switch apparatus together to form an aggregation port through configuring software settings, and each physical port composing the aggregation port is called a member port. The aggregation port merges bandwidths of the member ports so as to provide a high bandwidth which is several times over the bandwidth of each member port.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating ports on a switch apparatus.

FIG. 2A is a flowchart illustrating a method for traffic forwarding according to an example of the present disclosure.

FIG. 2B is a flowchart illustrating a method for traffic forwarding according to another example of the present disclosure.

FIG. 3 is a schematic diagram illustrating an example of the present disclosure.

FIG. 4 is a schematic diagram illustrating an example of the present disclosure.

FIG. 5 is a schematic diagram illustrating a structure of a control apparatus according to an example of the present disclosure.

FIG. 6A is a schematic diagram illustrating a hardware structure of the control apparatus according to an example of the present disclosure.

FIG. 6B is a schematic diagram illustrating a hardware structure of the control apparatus according to another example of the present disclosure.

FIG. 7 is a schematic diagram illustrating a structure of a switch apparatus according to an example of the present disclosure.

FIG. 8A is a schematic diagram illustrating a hardware structure of the switch apparatus according to an example of the present disclosure.

FIG. 8B is a schematic diagram illustrating a hardware structure of the switch apparatus according to another example of the present disclosure.

### DETAILED DESCRIPTION

Hereinafter, the present disclosure will be described in further detail with reference to the accompanying drawings and examples to make the technical solution and merits therein clearer.

In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

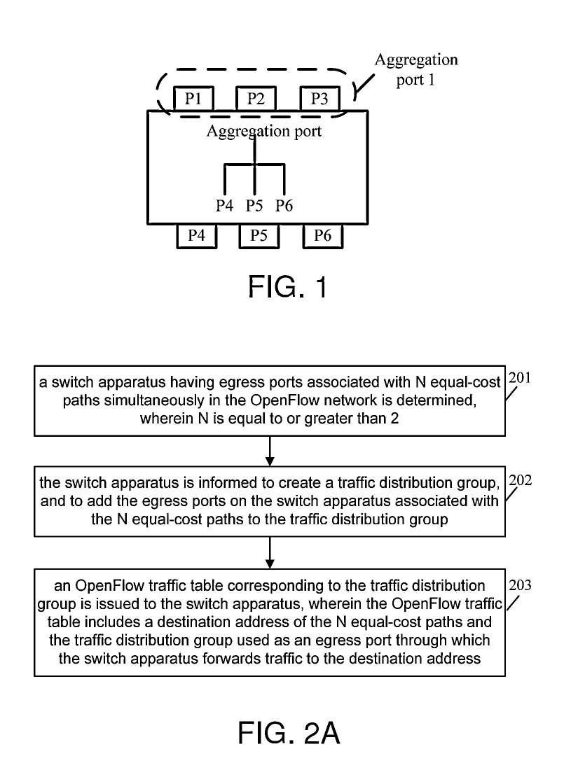

FIG. 1 is a schematic diagram illustrating ports on a switch apparatus. As shown in FIG. 1, to improve a network bandwidth between a switch apparatus and an opposite peer, physical ports P1, P2 and P3 on the switch apparatus are bound together to form an aggregation port 1. As such, as shown in FIG. 1, the switch apparatus has four ports at the forwarding plane, i.e., P4, P5, P6 and aggregation port 1. When receiving ingress traffic through a member port in the aggregation port 1, the switch apparatus marks the ingress traffic with a label of aggregation port 1, and forwards the traffic at the forwarding plane according to the marked label of the ingress traffic; when forwarding egress traffic through the aggregation port 1, the switch apparatus firstly obtains member ports of the aggregation port 1, i.e., P1, P2 and P3, then disperses the egress traffic to the P1, P2 and P3 by way of HASH for forwarding.

Usually, to ensure traffic forwarding, an aggregation port is strictly bound to its member ports, one physical port can only be bound to one aggregation port, namely, one physical port cannot belong to two or more aggregation ports simultaneously, otherwise, if a physical port is bound to two or more aggregation ports at the same time, it will lead to chaos of traffic forwarding. For example, in FIG. 1, physical ports P1, P2 and P3 only belong to aggregation port 1, and they can no longer belong to other aggregation ports, otherwise, it could not be determined which aggregation port's label should be marked on the ingress traffic received by any one of the physical ports P1, P2 and P3, which further leads to that the ingress traffic could not be forwarded unceasingly.

However, that one physical port can only be associated with one aggregation port will restrict an ability of a physical port to be associated with Equal-Cost Multi-Path (ECMP) paths in Layer Two Equal-Cost Multipath Routing (L2 ECMP) techniques, for example, in FIGS. 1, P1 to P3 are bound together to form an aggregation port 1, then, even if P3 and P4 are egress ports through which ECMP paths reach a destination, then P3 and P4 could not be bound together to form another aggregation port 2, which obviously restricts the ability of P3 to be associated with ECMP paths, and also leads to that L2 ECMP could only be applied to scenarios in which uplink or downlink networking are aggregated, and could not be applied to scenarios of mesh networking.

Examples of the present disclosure provide a method and an apparatus for traffic forwarding, which could improve the ability of a physical port to be associated with multiple ECMP paths.

In recent years Software Defined Networking (SDN) methods have been proposed. In SDN the control plane and data plane are located in different devices. Thus the data plane which includes a forwarding table for forwarding data flows is located in the switch apparatus, but the control plane which is responsible for higher level tasks including updating the contents of the forwarding table is located in a separate controller apparatus. Several switch apparatus may be controlled by the same controller apparatus. Typically the data plane of the switch apparatus is capable of recognizing traffic flows according to certain characteristics of the packets in the flow and forwards them according to the data plane or forwarding table. If the switch apparatus does not recognize a traffic flow, or does not know how to forward it, then it may send the traffic flow to the controller apparatus and the controller apparatus may determine how and to where the traffic flow should be forwarded and update the forwarding table of the switch apparatus accordingly. The controller apparatus and switch apparatus may communicate according to a SDN protocol. One example of SDN is Open Flow. The subsequent description below refers to OpenFlow, it will be understand that the teachings of the current disclosure may be applied to other types of SDN or SDN protocols.

An example of the present disclosure provides a method for traffic forwarding, which is applied to a control apparatus in a network, including:

A. determining a switch apparatus having egress ports associated with N equal-cost paths simultaneously in the network, wherein N is equal to or greater than 2;

B. informing the switch apparatus to create a traffic distribution group, and to add egress ports on the switch apparatus associated with the N equal-cost paths to the traffic distribution group; and

C. issuing, to the switch apparatus, a first traffic table corresponding to the traffic distribution group, wherein the first traffic table includes a destination address of the N equal-cost paths and the traffic distribution group used as an egress port through which the switch apparatus forwards traffic to the destination address.

An example of the present disclosure provides a method for traffic forwarding, which is applied to a switch apparatus in a network, including:

receiving, by the switch apparatus, a traffic distribution group creation notification sent by a control apparatus in the network when the switch apparatus has egress ports associated with N equal-cost paths simultaneously, creating a traffic distribution group according to the notification, and adding egress ports on the switch apparatus associated with the N equal-cost paths to the traffic distribution group, wherein N is equal to or greater than 2;

receiving from the control apparatus a first traffic table corresponding to the traffic distribution group, wherein the first traffic table includes a destination address of the N equal-cost paths and the traffic distribution group used as an egress port; and

when traffic is forwarded to the destination address, forwarding the traffic using the traffic distribution group in the first traffic table as an egress port.

An example of the present disclosure provides an apparatus for traffic forwarding, which is a control apparatus in a network, including: a processor, a storage unit, a network card and a memory, wherein,

the storage unit is adapted to store a first traffic table;

the memory is adapted to store computer instructions;

the processor is adapted to perform following operations through executing the computer instructions:

determining a switch apparatus having egress ports associated with N equal-cost paths simultaneously in the network, wherein N is equal to or greater than 2;

informing, through the network card, the switch apparatus to create a traffic distribution group, and to add egress ports on the switch apparatus associated with the N equal-cost paths to the traffic distribution group; and

issuing, through the network card, a first traffic table corresponding to the traffic distribution group to the switch apparatus, wherein the first traffic table includes a destination address of the N equal-cost paths and the traffic distribution group used as an egress port through which the switch apparatus forwards traffic to the destination address.

An example of the present disclosure provides a switch apparatus applied to traffic forwarding, which is applied to a network, including: a processor, a switch chip and a memory, wherein,

the memory is adapted to store computer instructions;

the processor is adapted to perform following operations through executing the computer instructions:

receiving, through the switch chip, a traffic distribution group creation notification sent by a control apparatus in the network when the switch apparatus has egress ports associated with N equal-cost paths simultaneously, creating a traffic distribution group according to the notification, and adding egress ports on the switch apparatus associated with the N equal-cost paths to the traffic distribution group, wherein N is equal to or greater than 2;

receiving, through the switch chip, from the control apparatus a first traffic table corresponding to the traffic distribution group, wherein the first traffic table includes a destination address of the N equal-cost paths and the traffic distribution group used as an egress port; and

when traffic is forwarded to the destination address, forwarding, through the switch chip, the traffic using the traffic distribution group in the first OpenFlow traffic table as an egress port.

In present disclosure, physical ports on a switch apparatus are divided to take on multiple ECMP paths rather than be bound together. Hereinafter, the method provided by the present disclosure is described.

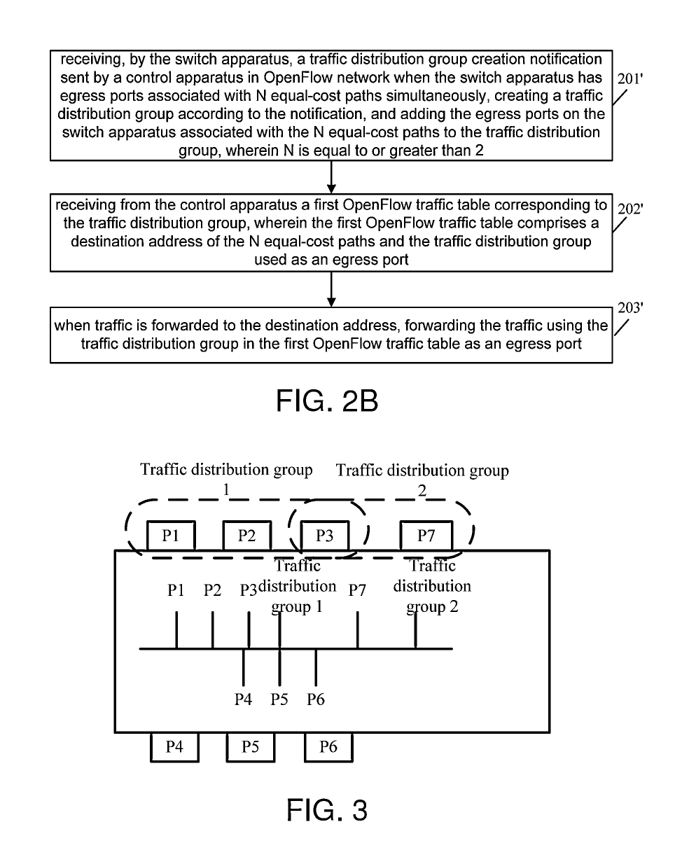

FIG. 2A is a flowchart illustrating a method for traffic forwarding according to an example of the present disclosure. The method is applied to a control apparatus (Open Flow Controller) in an Open Flow network. Open Flow is a research topic of Global Environment for Networking Innovations (GENI), the purpose of Open Flow is to allow researchers to take new experiments for network protocol in an existing commercial network, so that costs for building the experimental network are saved, and it is ensured that experimental data will be derived from a more realistic environment. With improvement of OpenFlow techniques, an application target of Open Flow has been extended to fields of wide area network (WAN) and data center. In the fields of WAN and data center, principles of OpenFlow are that: a control plane and a data plane are separated, these two parties communicate with each other using standard protocols; the data plane uses a flow-based way to forward, centralizes the control plane, provides open API interfaces for developing of third-parties; the data plane and control plane support virtualization.

Based on Open Flow, as shown in FIG. 2A, the control apparatus in an Open Flow network may perform following operations.

Block 201, a switch apparatus having egress ports associated with N equal-cost paths simultaneously in the OpenFlow network is determined, wherein N is equal to or greater than 2.

In the Open Flow network, a control apparatus holds information about apparatuses, interfaces and links of the whole network, and may calculate paths between any two apparatuses in the Open Flow network through path calculation, and rank optimized ECMP paths between these two apparatuses according to requirements of a controller. Herein, the path calculation and the determination of ECMP paths are not within the scope of the present disclosure, therefore they are not described with more emphases in the present disclosure. After that, the control apparatus determines the switch apparatus having egress ports associated with N equal-cost paths simultaneously in the ECMP paths from the Open Flow network.

Block 202, the switch apparatus is informed to create a traffic distribution group, and to add the egress ports on the switch apparatus associated with the N equal-cost paths to the traffic distribution group.

Preferably, one switch apparatus will not create only one traffic distribution group. In order to distinguish different traffic distribution groups on the same switch apparatus, a unique identifier may be configured for each traffic distribution group.

In addition, in block 202, the switch apparatus creates a traffic distribution group and adds the egress ports associated with the N equal-cost paths to the traffic distribution group, rather than binds each egress port, which ensures that one egress port is not restrict to be owned only by one traffic distribution group compared with conventional systems.

For example, as shown in FIG. 3, it is assumed that there are three equal-cost paths associated with a switch apparatus in FIG. 3 within paths from a source address 1 to a destination address 1, and egress ports on the switch apparatus associated with the three equal-cost paths respectively are P1, P2 and P3; and, there are two equal-cost paths associated with the switch apparatus in FIG. 3 within paths from a source address 2 to a destination address 2, and egress ports on the switch apparatus associated with the two equal-cost paths respectively are P3 and P7; based on this, the control apparatus notifies the switch apparatus to create two traffic distribution groups, which are recorded as traffic distribution group 1 and traffic distribution group 2, wherein the traffic distribution group 1 includes egress ports P1, P2 and P3, and the traffic distribution group 2 includes egress ports P3 and P7. It can be seen that, the egress port P3 on the switch apparatus belongs to two traffic distribution groups at the same time.

Block 203, an OpenFlow traffic table corresponding to the traffic distribution group is issued to the switch apparatus, wherein the Open Flow traffic table includes a destination address of the N equal-cost paths and the traffic distribution group used as an egress port through which the switch apparatus forwards traffic to the destination address.

Taking FIG. 3 as an example, when block 203 is performed, as two traffic distribution groups are created in block 202, two OpenFlow traffic tables corresponding to the two traffic distribution groups respectively are issued to the switch apparatus, i.e., two OpenFlow traffic tables are issued; wherein the OpenFlow traffic table corresponding to the traffic distribution group 1 includes the destination address 1 and the traffic distribution group 1 used as an egress port for destination address 1, and the Open Flow traffic table corresponding to the traffic distribution group 2 includes the destination address 2 and the traffic distribution group 2 used as an egress port for destination address 2. As such, when forwarding traffic sent to the destination address 1, the switch apparatus takes the traffic distribution group 1 as an egress port to forward the traffic (the principle of the destination address 2 is similar with that of the destination address 1).

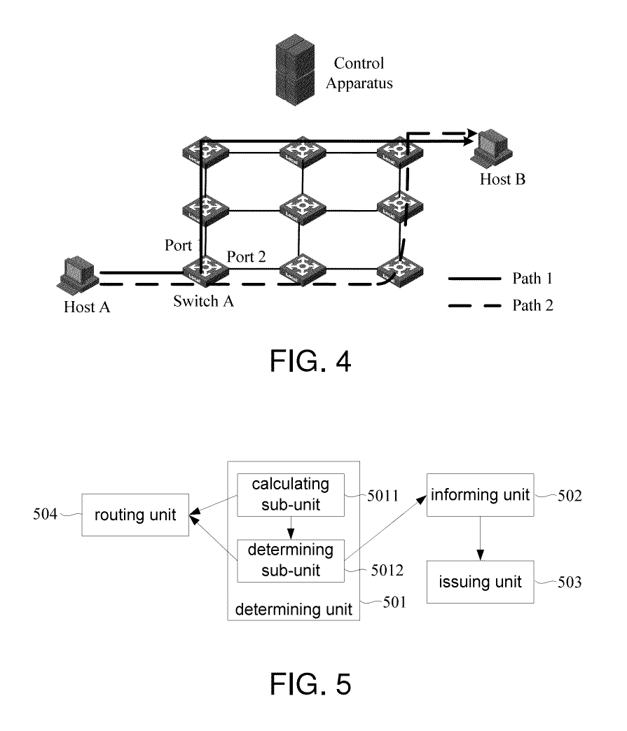

By this time, description of the process shown in FIG. 2A is completed. Hereinafter the process shown in FIG. 2A is described in further detail through FIG. 4.

In FIG. 4, a control apparatus (OpenFlow Controller) calculates ECMP paths from a host A to a host B, which are two paths respectively shown in FIG. 4: a path 1 and a path 2, wherein a switch apparatus A is associated with the two paths simultaneously, an egress port on the switch apparatus A corresponding to the path 1 is Port1, and an egress port corresponding to the path 2 is Port 2. Based on this, the control apparatus notifies the switch apparatus A to create a traffic distribution group, and add Port 1 and Port 2 to the created traffic distribution group; at the same time, the control apparatus issues to the switch apparatus A an OpenFlow traffic table corresponding to the created traffic distribution group, the Open Flow traffic table may include following entries: [destination address: Host B, egress port: identifier of the traffic distribution group]. After that, when sending traffic to the Host B, the switch apparatus A takes the traffic distribution group in the OpenFlow flow table in which the Host B is the destination address as an egress port to forward the traffic. It should be noted that, the ECMP in the present disclosure may be unidirectional. For example, in FIG. 4, ECMP paths from Host B to Host A are independent from ECMP paths from Host A to Host B, of which principles are alike, which are not repeated herein.

The above FIG. 2A to FIG. 4 are described under the circumstance that there exists a switch apparatus associated with N equal-cost paths simultaneously in the Open Flow network. When there does not exist ECMP paths among paths between two apparatuses calculated by the control apparatus, or, even though there exist ECMP paths among calculated paths between two apparatuses, but there does not exist a switch apparatus associated with the N equal-cost paths simultaneously, the control apparatus further performs following operations:

for each calculated path, the control apparatus issues, to a switch apparatus through which a calculated path passes, a second OpenFlow traffic table corresponding to an egress port of the calculated path on the switch apparatus, wherein the second OpenFlow traffic table at least includes: a destination address of the calculated path and the egress port on the switch apparatus corresponding to the calculated path.

As such, when the switch apparatus receives traffic through a port in a traffic distribution group or through a port which is not in a traffic distribution group, if there exists a first OpenFlow traffic table including a destination address of the traffic, the traffic is forwarded using the traffic distribution group in the first Open Flow traffic table as an egress port; if there exists a second Open Flow traffic table including the destination address of the traffic, the traffic is forwarded through an egress port in the second OpenFlow traffic table; namely, it is ensured that physical ports and traffic distribution groups may exist together at forwarding plane.

Wherein, that a switch apparatus forwards traffic using a traffic distribution group as an egress port may be implemented by ways of forwarding traffic through the aggregation port in conventional systems, i.e., the switch apparatus distributes, by way of HASH, the traffic to each port in the traffic distribution group for forwarding, or, the switch apparatus distributes, by way of polling, the traffic to each port in the traffic distribution group for forwarding, which ensures inter-port load balancing in the traffic distribution group; as such, it is also ensured that when a port in a traffic distribution group fails, traffic associated with the fault port will be distributed to other ports in the traffic distribution group through HASH, which achieves path fast switching of ECMP.

It can be seen from the above description, in present disclosure, traffic forwarding depends on OpenFlow techniques, rather than an existing MAC address learning mechanism, the reason is: as a traffic distribution group and a physical port appear together at forwarding plane, if it still depends on the MAC address learning mechanism to instruct layer-two forwarding, then packet forwarding through traffic distribution group could not be achieved, and then ECMP forwarding could not be achieved either. Taking FIG. 3 as an example, if a packet's source MAC address has been associated to P1 to P3, therefore, when the packet's source MAC address is taken as a destination MAC address and a packet is forwarded to the destination MAC address, according to the MAC address learning mechanism, the packet should be directly forwarded to any one of P1 to P3 in accordance with the destination MAC address, rather than be forwarded to the traffic distribution group 1, and therefore ECMP forwarding could not be achieved, thus, by means of OpenFlow techniques, the control apparatus issues the first OpenFlow traffic table or the second OpenFlow traffic table to instruct ECMP packet forwarding based on the traffic distribution group.

FIG. 2B is a flowchart illustrating a method for traffic forwarding according to another example of the present disclosure. The method is applied to a switch apparatus in OpenFlow network. Based on Open Flow, as shown in FIG. 2B, the switch apparatus in Open Flow network may perform following operations:

block 201′, receiving, by the switch apparatus, a traffic distribution group creation notification sent by a control apparatus in OpenFlow network when the switch apparatus has egress ports associated with N equal-cost paths simultaneously, creating a traffic distribution group according to the notification, and adding the egress ports on the switch apparatus associated with the N equal-cost paths to the traffic distribution group, wherein N is equal to or greater than 2;

block 202′, receiving from the control apparatus a first Open Flow traffic table corresponding to the traffic distribution group, wherein the first OpenFlow traffic table comprises a destination address of the N equal-cost paths and the traffic distribution group used as an egress port; and

block 203′, when traffic is forwarded to the destination address, forwarding the traffic using the traffic distribution group in the first OpenFlow traffic table as an egress port.

The method may further includes:

when the switch apparatus does not have egress ports associated with the N equal-cost paths simultaneously, receiving a second Open Flow traffic table which is issued by the control apparatus for each calculated path passing through the switch apparatus and corresponds to an egress port of each calculated path on the switch apparatus, wherein the second OpenFlow traffic table at least includes: a destination address of a calculated path and an egress port on the switch apparatus corresponding to the calculated path; and

when traffic received through a port in the traffic distribution group or through a port which is not in the traffic distribution group is forwarded through the switch apparatus, if there exists the first OpenFlow traffic table comprising a destination address of the traffic, forwarding the traffic using the traffic distribution group in the first Open Flow traffic table as an egress port; if there exists the second Open Flow traffic table comprising the destination address of the traffic, forwarding the traffic through an egress port in the second Open Flow traffic table.

In the above-mentioned method, when the traffic is forwarded using the traffic distribution group in the first OpenFlow traffic table as an egress port, the traffic may be distributed, by way of HASH or polling, to each port in the traffic distribution group for forwarding.

By this time, the description of the method provided by the present disclosure is completed. Hereinafter apparatuses provided by the present disclosure are described.

FIG. 5 is a schematic diagram illustrating a structure of a control apparatus according to an example of the present disclosure. The control apparatus is a control apparatus in OpenFlow network, as shown in FIG. 5, the control apparatus includes:

a determining unit 501, adapted to determine a switch apparatus having egress ports associated with N equal-cost paths simultaneously in OpenFlow network, wherein N is equal to or greater than 2;

an informing unit 502, adapted to inform the switch apparatus to create a traffic distribution group, and to add the egress ports on the switch apparatus associated with the N equal-cost paths to the traffic distribution group; and

an issuing unit 503, adapted to issue a first OpenFlow traffic table corresponding to the traffic distribution group to the switch apparatus, wherein the first OpenFlow traffic table includes a destination address of the N equal-cost paths and the traffic distribution group used as an egress port, so that when forwarding traffic to the destination address, the switch apparatus takes the traffic distribution group in the first OpenFlow traffic table as an egress port to forward the traffic.

The determining unit 501 may include:

a calculating sub-unit 5011, adapted to calculate paths between any two apparatuses in OpenFlow network; and

a determining sub-unit 5012, adapted to determine the switch apparatus having egress ports associated with N equal-cost paths simultaneously in the ECMP paths in the OpenFlow network when there exist optimal ECMP paths in the paths calculated by the calculating sub-unit 5011.

The control apparatus may further include:

a routing unit 504, adapted to issue, for each path calculated by the calculating sub-unit 5011, a second OpenFlow traffic table to a switch apparatus through which a calculated path passes when the determining sub-unit 5012 determines that the switch apparatus does not have egress ports associated with N equal-cost paths simultaneously in the OpenFlow network; wherein the second OpenFlow traffic table corresponds to an egress port of the calculated path on the switch apparatus and at least includes: a destination address of the calculated path and the egress port on the switch apparatus corresponding to the calculated path.

Therefore, when the switch apparatus receives traffic through a port in the traffic distribution group or through a port which is not in the traffic distribution group, if there exists a first OpenFlow traffic table including a destination address of the traffic, the traffic is forwarded using the traffic distribution group in the first OpenFlow traffic table as an egress port; if there exists a second OpenFlow traffic table including the destination address of the traffic, the traffic is forwarded through an egress port in the second OpenFlow traffic table.

The above-mentioned units may be implemented by software (e.g. machine readable instructions stored in a memory and executable by a processor), hardware (e.g., the processor of an application specific integrated circuit (ASIC)), or a combination thereof, which is not restricted by the example of the present disclosure.

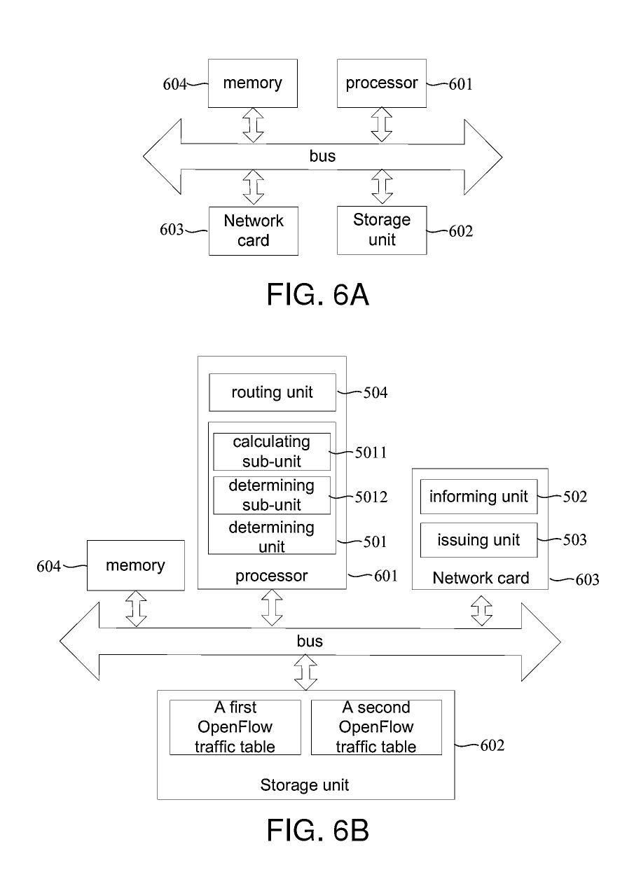

Implementation for each unit of the above-mentioned control apparatus in hardware is shown in FIG. 6A. FIG. 6A is a schematic diagram illustrating a hardware structure of the control apparatus according to an example of the present disclosure. The control apparatus is a control apparatus in OpenFlow network. As shown in FIG. 6A, the control apparatus includes: a processor 601, a storage unit 602, a network card 603 and a memory 604, wherein,

the storage unit 602 is adapted to store a first OpenFlow traffic table;

the memory 604 is adapted to store computer instructions;

the processor 601 is adapted to perform following operations through executing the computer instructions:

determining a switch apparatus having egress ports associated with N equal-cost paths simultaneously in the OpenFlow network, wherein N is equal to or greater than 2;

informing, through the network card 603, the switch apparatus to create a traffic distribution group, and to add the egress ports on the switch apparatus associated with the N equal-cost paths to the traffic distribution group; and

issuing, through the network card 603, a first OpenFlow traffic table corresponding to the traffic distribution group to the switch apparatus, wherein the first OpenFlow traffic table includes a destination address of the N equal-cost paths and the traffic distribution group used as an egress port through which the switch apparatus forwards traffic to the destination address.

Preferably, the processor 601 is adapted to perform following operations through executing the computer instructions:

calculating paths between any two apparatuses in OpenFlow network; and

determining the switch apparatus having egress ports associated with N equal-cost paths simultaneously in the ECMP paths from the OpenFlow network when there exists optimal ECMP paths in the calculated paths.

Preferably, the storage unit 602 is further adapted to store a second OpenFlow traffic table;

the processor 601 is adapted to perform following operations through executing the computer instructions:

when it is determined that the switch apparatus does not have egress ports associated with N equal-cost paths simultaneously in the OpenFlow network, for each calculated path, issuing, through the network card 603, to the switch apparatus through which a calculated path passes, a second OpenFlow traffic table corresponding to an egress port of the calculated path on the switch apparatus; wherein the second OpenFlow traffic table at least includes: a destination address of the calculated path and the egress port on the switch apparatus corresponding to the calculated path.

Therefore, when the switch apparatus receives traffic through a port in the traffic distribution group or through a port which is not in the traffic distribution group, if there exists a first OpenFlow traffic table including a destination address of the traffic, the traffic is forwarded using the traffic distribution group in the first Open Flow traffic table as an egress port; if there exists a second Open Flow traffic table including the destination address of the traffic, the traffic is forwarded through an egress port in the second Open Flow traffic table.

As can be seen from the above description, when the computer operations stored in the memory 604 are executed by the processor 601, functions of the determining unit 501 and the routing unit 504 are implemented, and functions of the informing unit 502 and the issuing unit 503 are implemented through the network card 603, therefore the hardware structure of the control apparatus provided by the example of the present disclosure can also be shown in FIG. 6B.

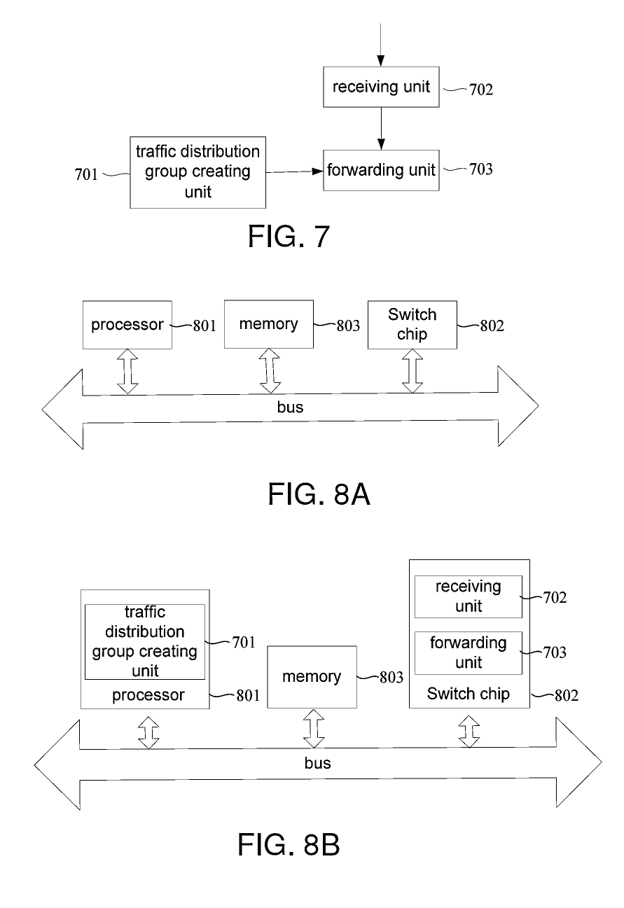

Preferably, the present disclosure further provides a switch apparatus applied to traffic forwarding, the switch apparatus is applied to Open Flow network. FIG. 7 is a schematic diagram illustrating a structure of the switch apparatus according to an example of the present disclosure. As shown in FIG. 7, the switch apparatus includes:

a traffic distribution group creating unit 701, adapted to receive a traffic distribution group creation notification sent by a control apparatus (OpenFlow Controller) in the Open Flow network when the switch apparatus has egress ports associated with N equal-cost paths simultaneously, create a traffic distribution group according to the notification, and add the egress ports on the switch apparatus associated with the N equal-cost paths to the traffic distribution group, wherein N is equal to or greater than 2;

a receiving unit 702, adapted to receive from the control apparatus a first OpenFlow traffic table corresponding to the traffic distribution group, wherein the first OpenFlow traffic table includes a destination address of the N equal-cost paths and the traffic distribution group used as an egress port; and

a forwarding unit 703, adapted to forward traffic using the traffic distribution group in the first OpenFlow traffic table as an egress port when the traffic is forwarded to the destination address.

Preferably, in the present disclosure, when the switch apparatus does not have egress ports associated with N equal-cost paths simultaneously, the receiving unit 702 is further adapted to receive a second OpenFlow traffic table which is issued by the control apparatus for each calculated path passing through the switch apparatus and corresponds to an egress port of each calculated path on the switch apparatus, wherein the second OpenFlow traffic table at least includes: a destination address of the path and the egress port on the switch apparatus corresponding to the path.

Based on this, when forwarding traffic received through a port in the traffic distribution group or through a port which is not in the traffic distribution group, if there exists a first OpenFlow traffic table including a destination address of the traffic, the forwarding unit 703 is further adapted to forward the traffic using the traffic distribution group in the first OpenFlow traffic table as an egress port; if there exists a second OpenFlow traffic table including the destination address of the traffic, the forwarding unit 703 is further adapted to forward the traffic through an egress port in the second Open Flow traffic table.

The forwarding unit 703 is adapted to forward the traffic using the traffic distribution group as the egress port by distributing, by way of HASH or polling, the traffic to each port in the traffic distribution group for forwarding.

The above-mentioned units may be implemented by software (e.g. machine readable instructions stored in a memory and executable by a processor), hardware (e.g. the processor of an ASIC), or a combination thereof, which is not restricted by the example of the present disclosure.

Implementation for each units of the above-mentioned switch apparatus in hardware may is shown in FIG. 8A. FIG. 8A is a schematic diagram illustrating a hardware structure of the switch apparatus according to an example of the present disclosure. The switch apparatus is applied to OpenFlow network. As shown in FIG. 8A, the switch apparatus includes a processor 801, a switch chip 802 and a memory 803, wherein,

the memory 803 is adapted to store computer instructions;

the processor 801 is adapted to perform following operations through executing the computer instructions:

receiving, through the switch chip 802, a traffic distribution group creation notification sent by a control apparatus in the Open Flow network when the switch apparatus has egress ports associated with N equal-cost paths simultaneously, creating a traffic distribution group according to the notification, and adding the egress ports on the switch apparatus associated with the N equal-cost paths to the traffic distribution group, wherein N is equal to or greater than 2;

receiving, through the switch chip 802, from the control apparatus a first OpenFlow traffic table corresponding to the traffic distribution group, wherein the first OpenFlow traffic table includes a destination address of the N equal-cost paths and the traffic distribution group used as an egress port; and

when traffic is forwarded to the destination address, forwarding, through the switch chip 802, the traffic using the traffic distribution group in the first Open Flow traffic table as an egress port.

Preferably, the processor 801 is adapted to perform following operations through executing the computer instructions:

when the switch apparatus does not have egress ports associated with N equal-cost paths simultaneously, receiving, through the switch chip 802, a second OpenFlow traffic table which is issued by the control apparatus for each calculated path passing through the switch apparatus and corresponds to an egress port of each calculated path on the switch apparatus, wherein the second OpenFlow traffic table at least includes: a destination address of a calculated path and an egress port on the switch apparatus corresponding to the calculated path; and

when traffic received through a port in the traffic distribution group or through a port which is not in the traffic distribution group is forwarded through the switch chip 802, if there exists a first OpenFlow traffic table including a destination address of the traffic, forwarding, through the switch chip 802, the traffic using the traffic distribution group in the first OpenFlow traffic table as an egress port; if there exists a second OpenFlow traffic table including the destination address of the traffic, forwarding, through the switch chip 802, the traffic through an egress port in the second Open Flow traffic table.

Preferably, the processor 801 is further adapted to perform following operations through executing the computer instructions:

when forwarding, through the switch chip 802, the traffic using the traffic distribution group in the first Open Flow traffic table as the egress port, distributing, by way of HASH or polling, the traffic to each port in the traffic distribution group for forwarding.

As can be seen from the above description, when the computer operations stored in the memory 803 are executed by the processor 801, function of the traffic distribution group creating unit 701 is implemented, and functions of the receiving unit 702 and the forwarding unit 703 are implemented through the switch chip 802, therefore the hardware structure of the switch apparatus provided by the example of the present disclosure can also be shown in FIG. 8B.

By this time, the descriptions of the apparatuses provided by the present disclosure are completed.

As can be seen from the above technical solution, in the present disclosure, a control apparatus in OpenFlow network determines a switch apparatus having egress ports associated with N equal-cost paths simultaneously in OpenFlow network, informs the switch apparatus to create a traffic distribution group and to add the egress ports on the switch apparatus associated with the N equal-cost paths to the traffic distribution group; and, issues a first OpenFlow traffic table to the switch apparatus, wherein the first OpenFlow traffic table includes a destination address of the N equal-cost paths and the traffic distribution group used as an egress port through which the switch apparatus forwards traffic to the destination address. Compared with conventional systems in which one physical port can only be bound to one aggregation port, the technical solution of the present disclosure divides physical ports on the switch apparatus in logic, rather than binds the physical ports on the switch apparatus, which ensures that one physical port may belong to several traffic distribution groups, improves the ability of a physical port to associate with multiple ECMP paths, and ensures that L2 ECMP can be applied to scenarios like mesh networking.

The above examples can be implemented by hardware, software or firmware or a combination thereof. For example the various methods, processes and functional units described herein may be implemented by a processor (the term processor is to be interpreted broadly to include a CPU, processing unit, ASIC, logic unit, or programmable gate array etc.). The processes, methods and functional units may all be performed by a single processor or split between several processors; reference in this disclosure or the claims to a ‘processor’ should thus be interpreted to mean ‘one or more processors’. The processes, methods and functional units be implemented as machine readable instructions executable by one or more processors, hardware logic circuitry of the one or more processors or a combination thereof. Further the teachings herein may be implemented in the form of a software product. The computer software product is stored in a non-transitory storage medium and comprises a plurality of instructions for making a computer apparatus (which can be a personal computer, a server or a network apparatus such as a router, switch, access point etc.) implement the method recited in the examples of the present disclosure.

The figures are only illustrations of an example, wherein the units or procedure shown in the figures are not necessarily essential for implementing the present disclosure. The units in the aforesaid examples can be combined into one unit or further divided into a plurality of sub-units.

The above are just several examples of the present disclosure, and are not used for limiting the protection scope of the present disclosure. Any modifications, equivalents, improvements, etc., made under the principle of the present disclosure should be included in the protection scope of the present disclosure.

What is claimed is:

1. A method for traffic forwarding, wherein the method is applied to a control apparatus in a network, comprising:
determining a switch apparatus having egress ports associated with N equal-cost paths simultaneously in the network, wherein N is equal to or greater than 2;
informing the switch apparatus to create a traffic distribution group, and to add the egress ports on the switch apparatus associated with the N equal-cost paths to the traffic distribution group; and
issuing, to the switch apparatus, a first traffic table corresponding to the traffic distribution group, wherein the first traffic table comprises a destination address of the N equal-cost paths and the traffic distribution group used as an egress port through which the switch apparatus forwards traffic to the destination address.

2. The method of claim 1, wherein the determining a switch apparatus having egress ports associated with N equal-cost paths simultaneously in the network comprises:
calculating paths between any two apparatuses in the network; and
when there exist optimal equal-cost multi-path (ECMP) paths in the calculated paths, determining the switch apparatus having the egress ports associated with the N equal-cost paths simultaneously in the network.

3. The method of claim 2, wherein:
when it is determined that the switch apparatus does not have the egress ports associated with the N equal-cost paths simultaneously in the network, for each calculated path, issuing, to a second switch apparatus through which a calculated path passes, a second traffic table corresponding to an egress port of the calculated path on the second switch apparatus, wherein the second traffic table at least comprises: a destination address of the calculated path and the egress port on the second switch apparatus corresponding to the calculated path.

4. The method of claim 1, wherein the network comprises an OpenFlow network.

5. A method for traffic forwarding, wherein the method is applied to a switch apparatus in a network, comprising:
receiving, by the switch apparatus, a traffic distribution group creation notification sent by a control apparatus in the network when the switch apparatus has egress ports associated with N equal-cost paths simultaneously, creating a traffic distribution group according to the notification, and adding the egress ports on the switch apparatus associated with the N equal-cost paths to the traffic distribution group, wherein N is equal to or greater than 2;
receiving from the control apparatus a first traffic table corresponding to the traffic distribution group, wherein the first traffic table comprises a destination address of the N equal-cost paths and the traffic distribution group used as an egress port; and
when traffic is forwarded to the destination address, forwarding the traffic using the traffic distribution group in the first traffic table as an egress port.

6. The method of claim 5, further comprising:
when the switch apparatus does not have the egress ports associated with the N equal-cost paths simultaneously, receiving a second traffic table which is issued by the control apparatus for each calculated path passing through the switch apparatus and corresponds to an egress port of each calculated path on the switch apparatus, wherein the second traffic table at least comprises: a destination address of a calculated path and an egress port on the switch apparatus corresponding to the calculated path; and
when traffic received through a port in the traffic distribution group or through a port which is not in the traffic distribution group is forwarded through the switch apparatus, when there exists the first traffic table comprising a destination address of the traffic, forwarding the traffic using the traffic distribution group in the first traffic table as an egress port; when there exists the second traffic table comprising the destination address of the traffic, forwarding the traffic through an egress port in the second traffic table.

7. The method of claim 6, wherein the forwarding the traffic using the traffic distribution group in the first traffic table as an egress port comprises:
distributed, by way of HASH or polling, the traffic to each port in the traffic distribution group for forwarding.

8. The method of claim 5, wherein the network comprises an OpenFlow network.

9. A control apparatus for traffic forwarding, wherein the control apparatus is applied to a network, comprising: a processor, a storage unit, a network card and a memory, wherein,
the storage unit is adapted to store a first traffic table;
the memory is adapted to store computer instructions;
the processor is adapted to perform following operations through executing the computer instructions:
determining a switch apparatus having egress ports associated with N equal-cost paths simultaneously in the network, wherein N is equal to or greater than 2;
informing, through the network card, the switch apparatus to create a traffic distribution group, and to add the egress ports on the switch apparatus associated with the N equal-cost paths to the traffic distribution group; and
issuing, through the network card, a first traffic table corresponding to the traffic distribution group to the switch apparatus, wherein the first traffic table comprises a destination address of the N equal-cost paths and the traffic distribution group used as an egress port through which the switch apparatus forwards traffic to the destination address.

10. The control apparatus of claim 9, wherein the processor is further adapted to perform following operations through executing the computer instructions:
calculating paths between any two apparatuses in the network; and
when there exist optimal equal-cost multi-path (ECMP) paths in the calculated paths, determining the switch apparatus having the egress ports associated with the N equal-cost paths simultaneously in the network.

11. The control apparatus of claim 10, wherein
the storage unit is further adapted to store a second traffic table; and
the processor is further adapted to perform following operations through executing the computer instructions:
when it is determined that the switch apparatus does not have the egress ports associated with the N equal-cost paths simultaneously in the network, for each calculated path, issuing, through the network card, to a second switch apparatus through which a calculated path passes, a second traffic table corresponding to an egress port of the calculated path on the second switch apparatus, wherein the second traffic table at least comprises: a destination address of the calculated path and the egress port on the second switch apparatus corresponding to the calculated path.

12. The control apparatus of claim 9, wherein the network comprises an OpenFlow network.

13. A switch apparatus for traffic forwarding, wherein the switch apparatus is applied to a network, comprising: a processor, a switch chip and a memory, wherein
the memory is adapted to store computer instructions;
the processor is adapted to perform following operations through executing the computer instructions:
receiving, through the switch chip, a traffic distribution group creation notification sent by a control apparatus in the network when the switch apparatus has egress ports associated with N equal-cost paths simultaneously, creating a traffic distribution group according to the notification, and adding the egress ports on the switch apparatus associated with the N equal-cost paths to the traffic distribution group, wherein N is equal to or greater than 2;
receiving, through the switch chip, from the control apparatus a first traffic table corresponding to the traffic distribution group, wherein the first traffic table comprises a destination address of the N equal-cost paths and the traffic distribution group used as an egress port; and
when traffic is forwarded to the destination address, forwarding, through the switch chip, the traffic using the traffic distribution group in the first traffic table as an egress port.

14. The switch apparatus of claim 13, wherein the processor is further adapted to perform following operations through executing the computer instructions:
when the switch apparatus does not have the egress ports associated with the N equal-cost paths simultaneously, receiving, through the switch chip, a second traffic table which is issued by the control apparatus for each calculated path passing through the switch apparatus and corresponds to an egress port of each calculated path on the switch apparatus, wherein the second traffic table at least comprises: a destination address of a calculated path and an egress port on the switch apparatus corresponding to the calculated path; and
when traffic received through a port in the traffic distribution group or through a port which is not in the traffic distribution group is forwarded through the switch chip, when there exists the first traffic table comprising a destination address of the traffic, forwarding, through the switch chip, the traffic using the traffic distribution group in the first traffic table as an egress port; when there exists the second traffic table comprising the destination address of the traffic, forwarding, through the switch chip, the traffic through an egress port in the second traffic table.

15. The switch apparatus of claim 14, wherein the processor is further adapted to perform following operations through executing the computer instructions:
when forwarding, through the switch chip, the traffic using the traffic distribution group in the first traffic table as the egress port, distributing, by way of HASH or polling, the traffic to each port in the traffic distribution group for forwarding.

16. The switch apparatus of claim 13, wherein the network comprises an OpenFlow network.
